(19) United States
(12) Patent Application Publication
(10) Pub. No.: US 2008/0244985 A1
(43) Pub. Date: Oct. 9, 2008

(54) DAMAGE PROTECTION DEVICE FOR AN AIRCRAFT

(76) Inventors: Kevin D. Walters, St. Charles, MO (US); Travis T. Marshall, St. Peters, MO (US)

Correspondence Address: KLEIN, O'NEILL & SINGH, LLP, 43 CORPORATE PARK, SUITE 204, IRVINE, CA, 92606, US

(21) Appl. No.: 11/697,644

(22) Filed: Apr. 6, 2007

(51) Int. Cl. E06B 7/16

(52) U.S. Cl. 49/478.1; 49/475.1

(57) ABSTRACT

A exposed edge protection device molded from an elastomer or a combination of elastomers of varying durometers formed together to match the outer mold line of an exposed edge. The device may include encapsulated flexible magnets providing for a durable monolithic device produced cost-effectively in a single-step process.

This invention was made with Government support under Contract No. MDA972-99-9-0003 awarded by the Navy Unmanned Combat Air System (Navy UCAS). The Government has certain rights in this invention.

### BACKGROUND

1. Field of the Invention

The present invention relates to a protection device, and in particularly to a device used to protect exposed edges on an aircraft.

2. Related Art

Aircraft door seals are designed to be thin in profile and lightweight, especially on high performance aircraft. In some instances, door seals may be fabricated from metallic or composite materials with sections as thin as 0.030″ thick. As a result, door seals are not tolerant to damage caused by ground operations.

Accordingly, since ground operations, such as fueling, maintenance, inspections, and stores loading are performed on a daily basis, exposed door seals are prone to damage in the form of dents, gouges, or delaminations.

What is needed is an edge protection device which can adequately protect exposed edges on an aircraft and other similar structures that is lightweight, inexpensive and simple to manufacture.

### SUMMARY

In light of the foregoing background, an apparatus for protecting an exposed edge structure on an aircraft is provided according to the various embodiments of the present invention.

One such exemplary exposed edge includes an aircraft door seal. In one embodiment, the present invention provides an effective protection device that slips over the exposed edge of a structure and adheres to the structure without using any special features built into the edge structure.

In one aspect, the door seal protection device may be molded from an elastomer or a combination of elastomers of varying durometers formed together to match the shape of an aircraft door seal outer mold line. The device may include encapsulated flexible magnets providing for a durable monolithic device produced cost-effectively in a single-step process and having an integral attachment means to ferrous structures or coatings.

The device is designed to protect the aircraft door seals from replenishment and maintenance-induced damage (human contact, fuel/hydraulic fluid/air hoses, equipment and ordinance loaders, work stand impacts, and the like). The device also provides a measure of safety for the user from cuts, gouges, or head impacts. The device is designed to be resistant to environmental conditions, such as temperature, UV light, and chemicals, typically found in aircraft operating environments.

### BRIEF DESCRIPTION OF THE DRAWINGS

Having thus described the invention in general terms, reference will now be made to the accompanying drawings, which are not necessarily drawn to scale, and wherein:

FIG. 1 is a simplified cross-sectional view of an edge protection device in accordance with an embodiment of the present disclosure;

FIG. 2 is an illustration of a representative application of the edge protection device of FIG. 1 in accordance with an embodiment of the present disclosure; and

FIG. 3 is a simplified cross-sectional view of an edge protection device in accordance with an embodiment of the present disclosure.

### DETAILED DESCRIPTION

The disclosure now will be described more fully hereinafter with reference to the accompanying drawings, in which some, but not all embodiments are shown. The disclosure may be embodied in many different forms and should not be construed as limited to the embodiments set forth herein. Like numbers refer to like elements throughout.

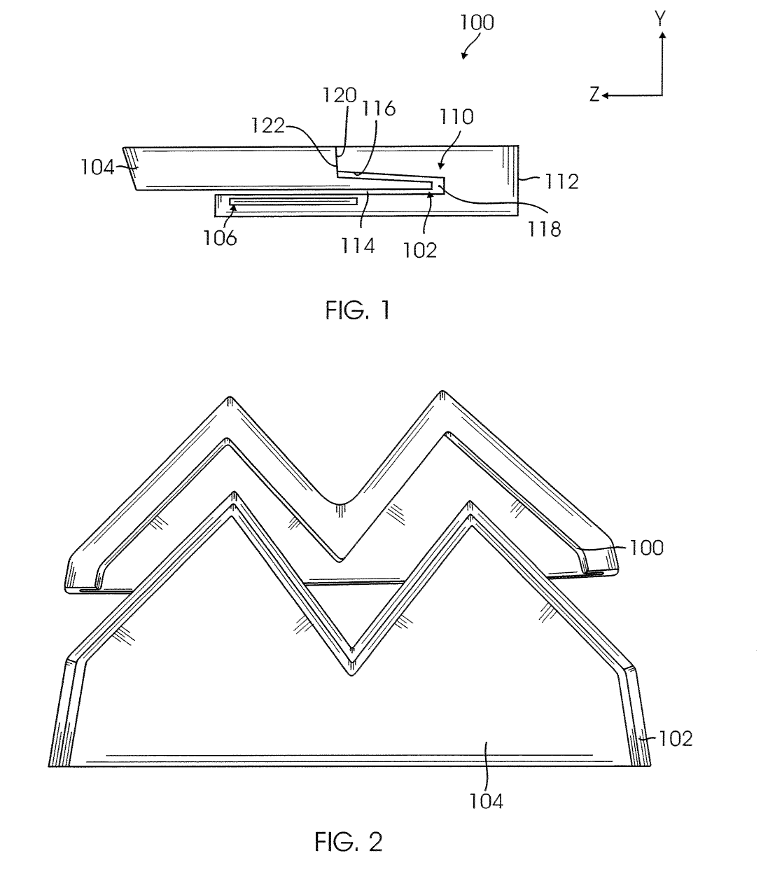

FIG. 1 is a simplified cross-sectional view of an edge protection device 100 (hereinafter “protection device 100”) in accordance with an embodiment of the present disclosure. In this exemplary embodiment, protection device 100 is described for use with door seal structures, however, it should be understood that protection device 100 may be adapted for use with any exposed edge on an aircraft while remaining within the scope of the disclosure.

In the exemplary embodiment, as also illustrated in FIG. 2, protection device 100 may be designed to conform to door seal 102 which is typically part of a larger door assembly 104.

Referring again to FIG. 1, protection device 100 includes a magnet material 106 embedded into an elastomeric body 110. Elastomeric body 110 may include an elastomer of a predetermined durometer or a combination of elastomers formed together having a range of durometers, such as between shore 60A thru 100A, for example shore 95A. The unique section profile and the durometer of the elastomer of protection device 100 results in the impact resistance required to protect the underlying door assembly 104 and door seal 102.

In one embodiment, elastomeric body 110 is made of an impact-absorbing elastomeric material, such as, solid Urethane or Hapflex™ elastomers commercially available from Hapco, Inc.

Protection device 100 is fabricated by molding either in an open or closed mold formed to the desired shape. During the molding process various information may be embossed into elastomeric body 110, such as information required of such devices, for example, identification numbers, serial numbers, and cautionary messages, such as “Remove Before Flight.”

In one embodiment, elastomeric body 110 may be tinted, for example, with red pigment, so as to provide a greater level of safety for users traversing in the vicinity of protection device 100. One such pigment is 6141 pigment—Red, available from BJB Enterprises, Inc.

As illustrated in FIG. 1, elastomeric body 110 includes a pocket 114, having an internal surface 116. Pocket 114 is configured to insertably receive and thus surround door seal 102.

In one embodiment, gaps or empty spaces may be created between door seal 102 and internal surface 116 of pocket 114. For example, gap 118 ensures that external forces that impact or otherwise affect protection device 100 are not transferred to door seal 102. Gap 118 may be designed to any dimension that provides an adequate relief tolerance from compression or relative movement of protection device 100.

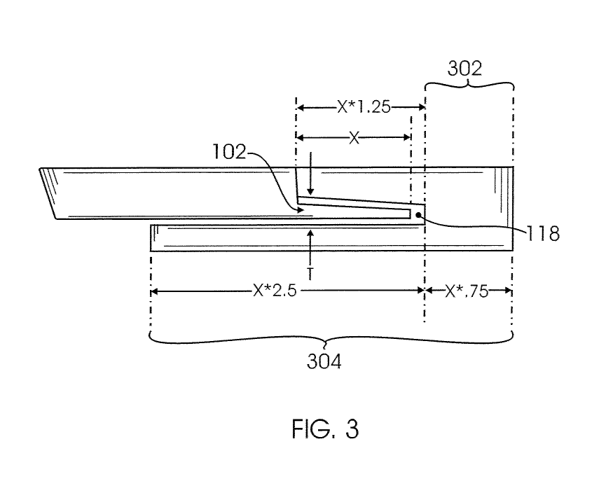

In one particular embodiment shown in FIG. 3, gap 118 may be dimensioned by multiplying the width “X” of door seal 102 by a multiplier, such as 1.25. The perimeter of a remaining cover portion 302 may be derived by multiplying width X by a multiplier, such as 0.75. The resulting cover leg 304 is set back from the perimeter by summing (X*0.75)+(X*2.5).

Gap “T” shown in FIG. 3 is determined by summing the thickness of door seal 102, (allowing for approximately an additional 8%-10% thickness when door seal 102 is made of a composite material), a gap of adequate dimension, for example, about 0.03″ (±0.02) and paint (if any).

Referring again to FIG. 2, in one embodiment, protection device 100 includes a force transferring or reaction surface 120. Reaction surface 120 is positioned to contact a corresponding door reaction surface 122 of door assembly 104, which is away from door seal 102. In this manner, any external force impacting protection device 100 in the z-axis direction may be transferred into door assembly 104 via the mating of the reaction surfaces 120 and 122.

For external forces impacting protection device 100 in the y-axis direction, protection device 100 is configured to distribute the impact energy over the relatively large area that internal surface 116 covers across door seal 102 and door assembly 104.

In one embodiment, magnet material 106, which may be a plurality of individual magnetic structures or, alternatively, a sheet of flexible magnetic material, may be embedded into protection device 100 to provide for retention of protection device 100 onto door assembly 104. The embedding of magnet material 106 into protection device 100 protects magnet material 106 from weathering.

Magnetic material 106 allows protection device 100 to be attached to a ferrous door assembly or a door assembly covered with a ferrous material, thereby eliminating the need to rely on cords or pins, which may, alternatively, be used for attaching protection device 100 to a non-ferrous door assembly.

It is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus to protect an exposed edge of a structure comprising:
a body molded from an elastomer to match the shape of an exposed edge of a structure; and
a securing mechanism embedded within the molded body providing for a monolithic device.

2. The apparatus of claim 1, wherein the molded body defines a pocket configured to receive the exposed edge of the structure.

3. The apparatus of claim 2, wherein the pocket further defines a gap to provide relief tolerance from compressive forces or the relative movement of the exposed edge structure and the molded body.

4. The apparatus of claim 1, wherein the molded body comprises a combination of elastomers of varying durometers for a desired resilience.

5. The apparatus of claim 4, wherein the varying durometers range from between about shore 60A to 100A.

6. The apparatus of claim 1, wherein the securing mechanism comprises at least one magnet.

7. The apparatus of claim 6, wherein the at least one magnet comprises an encapsulated magnet.

8. The apparatus of claim 6, wherein the at least one magnet comprises a flexible magnet.

9. The apparatus of claim 1, wherein the exposed edge of a structure comprises an aircraft edge structure.

10. The apparatus of claim 1, wherein the elastomer comprises Urethane.

11. The apparatus of claim 1, wherein the elastomer comprises a tint.

12. An apparatus to protect an exposed edge of a structure comprising:
a body molded from an elastomer to match the shape of an exposed door seal on a door structure, the molded body defining a pocket configured to receive the exposed door seal; and
at least one magnet embedded within the molded body providing for a monolithic device.

13. The apparatus of claim 12, wherein the pocket further defines a gap to provide relief tolerance from compressive forces or the relative movement of the exposed door seal.

14. The apparatus of claim 12, wherein the molded elastomer body comprises a combination of elastomers of varying durometers.

15. The apparatus of claim 14, wherein the varying durometers range from between about shore 60A to 100A.

16. The apparatus of claim 12, wherein the at least one magnet comprises an encapsulated magnet.

17. The apparatus of claim 12, wherein the at least one magnet comprises a flexible magnet.

18. The apparatus of claim 12, wherein the elastomer comprises Urethane.

19. The apparatus of claim 12, wherein the elastomer comprises a tint.

20. An apparatus to protect an exposed edge of a structure comprising:
a body molded from an elastomer to match the shape of an exposed door seal on a door assembly, the molded body defining a pocket configured to receive the exposed door seal, said pocket defining a gap to provide relief tolerance around said door seal, said molded body having a first surface which contacts the door structure away from the door seal structure to direct impact energy into said door assembly; and
a securing means integrated with the molded body for securing said molded body to said door assembly.
